(19) United States
(12) Patent Application Publication
(10) Pub. No.: US 2024/0305729 A1
(43) Pub. Date: Sep. 12, 2024

(54) IMAGE-READING APPARATUS AND IMAGE-FORMING SYSTEM

(71) Applicant: FUJIFILM Business Innovation Corp., Tokyo (JP)

(72) Inventors: Satoshi URUSHIBATA, Kanagawa (JP); Tadashi SUGIZAKI, Kanagawa (JP)

(73) Assignee: FUJIFILM Business Innovation Corp., Tokyo (JP)

(21) Appl. No.: 18/363,055

(22) Filed: Aug. 1, 2023

(30) Foreign Application Priority Data
Mar. 7, 2023 (JP) 2023-034663

(51) Int. Cl. H04N 1/00; H04N 1/60

(52) U.S. Cl. CPC H04N 1/00734; H04N 1/00623; H04N 1/0079; H04N 1/00981; H04N 1/6086; H04N 2201/0094; H04N 2201/04713

(57) ABSTRACT

An image-reading apparatus includes: a light-receiving unit that receives reflected light from a recording medium; a substrate that supports the light-receiving unit; an optical member that is located at a position different from a position of the substrate in a substrate thickness direction corresponding to a thickness direction of the substrate and that guides the reflected light from the recording medium to the light-receiving unit; and a supply unit that supplies cooling gas that is used to cool the substrate to the substrate. The cooling gas that is supplied to the substrate flows along the substrate.

### CROSS-REFERENCE TO RELATED APPLICATIONS

This application is based on and claims priority under 35 USC 119 from Japanese Patent Application No. 2023-034663 filed Mar. 7, 2023.

### BACKGROUND

### (i) Technical Field

The present disclosure relates to an image-reading apparatus and an image-forming system.

### (ii) Related Art

Japanese Unexamined Patent Application Publication No. 2004-45506 discloses that an image-reading apparatus that includes a light source that illuminates an original and that reads an image on the original that moves with respect to the light source that is stationary includes an air blasting unit that sends air from a location outside the image-reading apparatus into the image-reading apparatus.

Japanese Unexamined Patent Application Publication No. 2016-122988 discloses that a first blast path to send air in a scanning direction and a second blast path to send air in a sub-scanning direction are formed inside a housing and that dust collection efficiencies of air filters in the blast paths in the scanning direction are higher than those in the sub-scanning direction.

Japanese Unexamined Patent Application Publication No. 2007-114265 discloses an apparatus that includes a cooling mechanism that performs a cooling process in a housing merely by circulating interior air in the housing that contains a member for reading a document image.

### SUMMARY

An image-reading apparatus includes a light-receiving unit, a substrate that supports the light-receiving unit, and an optical member that guides reflected light from a recording medium to the light-receiving unit.

If gas for cooling the substrate that supports the light-receiving unit is supplied to the optical member, then dust that is contained in the gas, for example, adheres to the optical member, and the optical member is likely to get dirty.

Aspects of non-limiting embodiments of the present disclosure relate to an optical member that is unlikely to get dirty, unlike the case where air for cooling a substrate that supports a light-receiving unit is likely to move toward an optical member that guides reflected light from a recording medium to the light-receiving unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image-reading apparatus including a light-receiving unit that receives reflected light from a recording medium; a substrate that supports the light-receiving unit; an optical member that is located at a position different from a position of the substrate in a substrate thickness direction corresponding to a thickness direction of the substrate and that guides the reflected light from the recording medium to the light-receiving unit; and a supply unit that supplies cooling gas that is used to cool the substrate to the substrate. The cooling gas that is supplied to the substrate flows along the substrate.

### BRIEF DESCRIPTION OF THE DRAWINGS

Exemplary embodiments of the present disclosure will be described in detail based on the following figures, wherein:

FIG. 1 illustrates the entire configuration of an image-forming system;

FIG. 2 illustrates an example of the structure of hardware of a controller;

FIG. 3 illustrates an image forming apparatus;

FIG. 4 illustrates an inner structure of an upper image-reading member;

FIG. 5 illustrates the inner structure of the upper image-reading member viewed from above;

FIG. 6 illustrates a portion of the upper image-reading member viewed in a direction illustrated by using an arrow VI in FIG. 5;

FIG. 7 is a perspective view of the structure of the vicinity of a substrate;

FIG. 8 is a perspective view in the case where an inner portion of the upper image-reading member is viewed from above;

FIG. 9 illustrates a comparative example;

FIG. 10 is a diagram obtained by adding imaginary lines into FIG. 5;

FIG. 11 illustrates another example of the structure of the upper image-reading member; and

FIG. 12 illustrates another example of the structure of the upper image-reading member.

### DETAILED DESCRIPTION

An exemplary embodiment of the present disclosure will hereinafter be described with reference to the drawings.

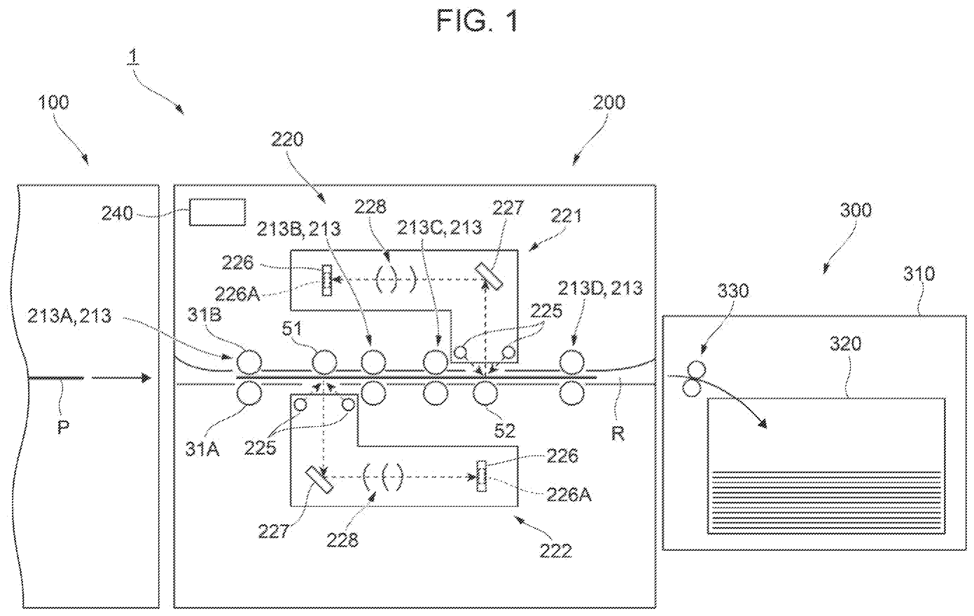

FIG. 1 illustrates the entire configuration of an image-forming system 1.

The image-forming system 1 according to the present exemplary embodiment includes an image forming apparatus 100 that forms an image on paper P that is an example of a recording medium, an inspection apparatus 200 that inspects the image that is formed on the paper P by using the image forming apparatus 100, and a paper container apparatus 300 that contains the paper P that is discharged from the inspection apparatus 200.

The image-forming system 1 has a function of inspecting the image that is formed on the paper P and is also referred to as an image inspection system.

The inspection apparatus 200 has a function of transporting the paper P that is an example of the recording medium and is also referred to as a recording-medium-transporting apparatus. The inspection apparatus 200 has a function of reading the image that is formed on the paper P and is also referred to as an image-reading apparatus.

The image forming apparatus 100 that functions as an image-forming unit acquires image data on which the image to be formed is based from, for example, a personal computer (PC) not illustrated.

The image forming apparatus 100 forms the image on the paper P that is an example of the recording medium by using a material such as toner, based on the acquired image data.

A mechanism for forming the image on the paper P is not particularly limited. The image is formed on the paper P by using, for example, an electrophotographic system or an ink-jet system.

The inspection apparatus 200 has a paper transport path R that is an example of a transport path along which the paper P that is discharged from the image forming apparatus 100 is transported.

The inspection apparatus 200 includes multiple transport rollers 213 that are examples of a transport unit that transports the paper P along the paper transport path R. According to the present exemplary embodiment, the multiple transport rollers 213 transport the paper P to a downstream position.

According to the present exemplary embodiment, an upstream transport roller 213A of the transport rollers 213 is located at the most upstream position in the transport direction of the paper P. A downstream transport roller 213D is disposed at the most downstream position in the transport direction of the paper P.

A first intermediate transport roller 213B and a second intermediate transport roller 213C that is located downstream of the first intermediate transport roller 213B are disposed between the upstream transport roller 213A and the downstream transport roller 213D.

The transport rollers 213 include respective drive rollers 31A that are rotationally driven and respective driven rollers 31B that are pressed against the drive rollers 31A and that rotate by receiving driving force from the drive rollers 31A.

The driven rollers 31B receive the driving force from the drive rollers 31A at contact portions at which the drive rollers 31A and the driven rollers 31B are in contact with each other. The driven rollers 31B rotate by receiving the driving force from the drive rollers 31A as the drive rollers 31A rotate.

The inspection apparatus 200 also includes image-reading members 220 that read the image that is formed on the paper P.

According to the present exemplary embodiment, an upper image-reading member 221 and a lower image-reading member 222 that are examples of an image-reading unit are provided as the image-reading members 220.

The upper image-reading member 221 is located above the paper transport path R. The upper image-reading member 221 reads an image that is formed on an upper surface that is an example of a first surface of two surfaces that the paper P has.

The lower image-reading member 222 is located below the paper transport path R. The lower image-reading member 222 reads an image that is formed on a lower surface that is an example of a second surface of the two surfaces that the paper P has.

The inspection apparatus 200 also includes a controller 240. The controller 240 controls components that are included in the inspection apparatus 200.

The upper image-reading member 221 and the lower image-reading member 222 include respective light sources 225 that radiate light to the paper P, respective light-receiving units 226 that receive reflected light from the paper P, and respective light-reflecting members 227 that reflect the reflected light from the paper P and that guide the reflected light to the light-receiving units 226.

The light-receiving units 226 include multiple light-receiving elements 226A that include, for example, photodiodes. The reflected light from the paper P is received by the multiple light-receiving elements 226A.

The multiple light-receiving elements 226A are arranged in a single direction. Specifically, the multiple light-receiving elements 226A are arranged in a direction perpendicular to the sheet in FIG. 1.

In other words, the multiple light-receiving elements 226A are arranged in a direction that is perpendicular to the transport direction of the paper P and that is perpendicular to the thickness direction of the paper P that is transported in the inspection apparatus 200.

The upper image-reading member 221 and the lower image-reading member 222 include respective imaging optical systems 228 such as lenses that image the reflected light from the light-reflecting members 227 on the light-receiving units 226.

According to the present exemplary embodiment, the upper image-reading member 221 and the lower image-reading member 222 are image-reading members that include reduction optical systems.

According to the present exemplary embodiment, an upper rotator 51 that is rotatable is opposite a position at which the lower image-reading member 222 is installed with the paper transport path R interposed therebetween. A lower rotator 52 that is rotatable is opposite a position at which the upper image-reading member 221 is installed with the paper transport path R interposed therebetween.

According to the present exemplary embodiment, a drive motor (not illustrated) that is a drive source for rotating the upper rotator 51 and a drive motor (not illustrated) that is a drive source for rotating the lower rotator 52 are provided.

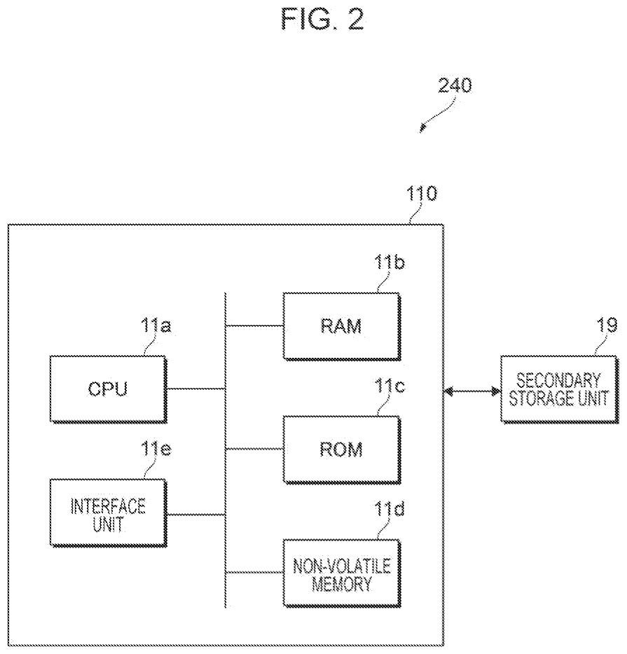

FIG. 2 illustrates an example of the structure of hardware of the controller 240. The controller 240 functions by using a computer.

The controller 240 includes an arithmetic processing unit 110 that performs digital arithmetic processing in accordance with a program and a secondary storage unit 19 that stores information.

The secondary storage unit 19 functions by using, for example, an existing information storage device such as a hard disk drive (HDD), a semiconductor memory, or a magnetic tape.

The arithmetic processing unit 110 includes a CPU 11a that is an example of a processor.

The arithmetic processing unit 110 also includes a RAM 11b that is used, for example, as a work memory for the CPU 11a and a ROM 11c that stores, for example, a program that is run by the CPU 11a.

The arithmetic processing unit 110 also includes a non-volatile memory 11d that is rewritable and that is capable of storing data even in the case where power supply is disconnected and an interface unit 11e that controls a component such as a communication unit that is connected to the arithmetic processing unit 110.

For example, the non-volatile memory 11d includes a flash memory or a SRAM backed up by using a battery. The secondary storage unit 19 stores various kinds of information such as a program that is run by the arithmetic processing unit 110.

According to the present exemplary embodiment, the arithmetic processing unit 110 reads a program that is stored in the ROM 11c or the secondary storage unit 19, and processing to be performed by the inspection apparatus 200 is consequently performed.

The program that is run by the CPU 11a may be provided to the inspection apparatus 200 with the program stored in a computer readable recording medium such as a magnetic recording medium (a magnetic tape or a magnetic disk), an optical recording medium (an optical disk), an optical magnetic recording medium, or a semiconductor memory. The program that is run by the CPU 11a may be provided to the inspection apparatus 200 by using a communication system such as the internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The image-forming system 1 will be further described with reference to FIG. 1.

The paper container apparatus 300 includes a housing 310. The paper container apparatus 300 also includes a paper loader 320.

The paper loader 320 is installed in the housing 310. According to the present exemplary embodiment, the paper P that is sequentially discharged from the inspection apparatus 200 is loaded on the paper loader 320.

The paper container apparatus 300 also includes feed rollers 330 that feed the paper P that is discharged from the inspection apparatus 200 to the paper loader 320.

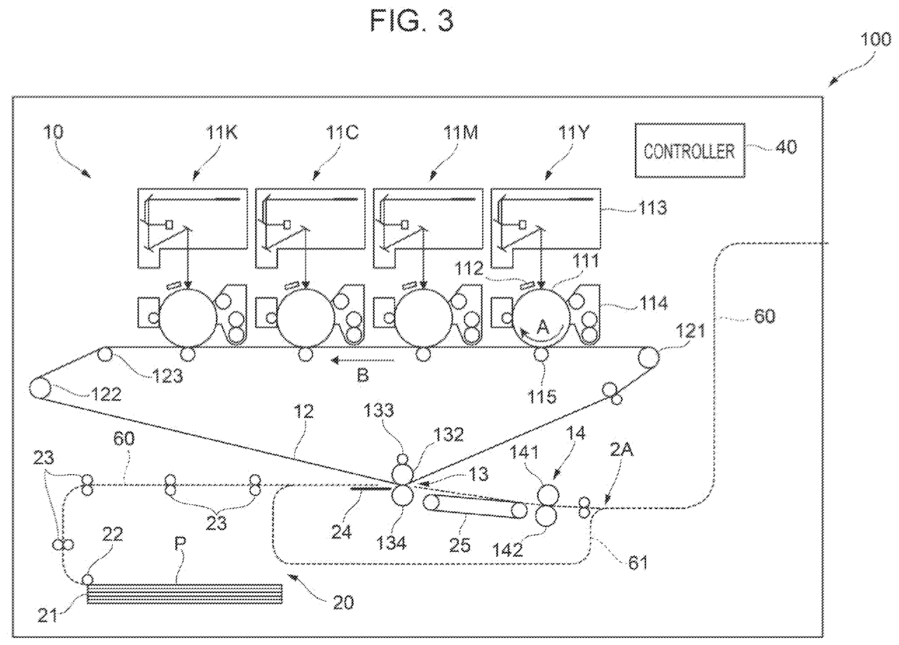

FIG. 3 illustrates the image forming apparatus 100.

In FIG. 3, an example of the image forming apparatus 100 is illustrated. The structure of the image forming apparatus 100 is not limited to that illustrated in FIG. 3. The image forming apparatus 100 illustrated in FIG. 3 forms an image by using the electrophotographic system. However, the image forming apparatus 100 may form the image by using, for example, the ink-jet system.

The image forming apparatus 100 may form the image by using another system other than the electrophotographic system and the ink-jet system.

The image forming apparatus 100 includes an image-forming member 10, a paper transport member 20, and a controller 40.

The image-forming member 10 includes image formation units 11 (11Y, 11M, 11C, and 11K), an intermediate transfer belt 12, a second transfer portion 13, and a fixing unit 14.

According to the present exemplary embodiment, the four image formation units 11Y, 11M, 11C, and 11K for respective four colors of yellow (Y), magenta (M), cyan (C), and black (K) are provided as the image formation units 11.

The four image formation units 11Y, 11M, 11C, and 11K are arranged in a direction in which the intermediate transfer belt 12 moves and form toner images by using the electrophotographic system.

The four image formation units 11Y, 11M, 11C, and 11K include respective photoconductor drums 111, respective charging members 112, respective exposure members 113, respective developing members 114, and respective first transfer portions 115.

The four image formation units 11Y, 11M, 11C, and 11K form the toner images in the respective colors of YMCK and transfer the formed toner images to the intermediate transfer belt 12. Consequently, a toner image is formed on the intermediate transfer belt 12 by stacking the toner images in the respective colors of YMCK.

The photoconductor drums 111 rotate at a predetermined speed in the direction of an arrow A in the figure. The charging members 112 charge the circumferential surfaces of the photoconductor drums 111 so as to have a predetermined potential. The exposure members 113 radiate light to the circumferential surfaces of the photoconductor drums 111 that are charged and form electrostatic latent images on the circumferential surfaces of the photoconductor drums 111.

The developing members 114 form the toner images by applying toner to the electrostatic latent images that are formed on the circumferential surfaces of the photoconductor drums 111. The first transfer portions 115 transfer the toner images that are formed on the circumferential surfaces of the photoconductor drums 111 to the intermediate transfer belt 12.

A voltage that has polarity opposite the charge polarity of the toner is applied to the first transfer portions 115. Consequently, the toner images that are formed on the circumferential surfaces of the photoconductor drums 111 are sequentially attracted to the intermediate transfer belt 12 in an electrostatic manner. As a result, a color toner image that is stacked into a single image is formed on the intermediate transfer belt 12. The intermediate transfer belt 12 is supported by multiple roll members. The intermediate transfer belt 12 is a belt member that circulates in the direction of an arrow B in the figure.

According to the present exemplary embodiment, a drive roller 121 that is driven by a motor not illustrated and that drives the intermediate transfer belt 12, a tension roller 122 that applies tension to the intermediate transfer belt 12, an idle roller 123 that supports the intermediate transfer belt 12, and a backup roller 132 are provided as the roll members.

The paper transport member 20 includes a paper container member 21 that contains stacked pieces of the paper P and a pickup roller 22 that feeds the paper P that is contained in the paper container member 21 and that transports the paper P.

The paper transport member 20 also includes transport rollers 23 that transport the paper P that is fed by the pickup roller 22 along a paper transport path 60 and a guide portion 24 that guides the paper P that is transported by the transport rollers 23 to the second transfer portion 13.

The paper transport member 20 also includes a transport belt 25 that transports the paper P to the fixing unit 14 after second transfer.

The second transfer portion 13 includes a second transfer roller 134 that is in contact with an outer surface of the intermediate transfer belt 12 and the backup roller 132 that is located inside the intermediate transfer belt 12 and that serves as a facing electrode for the second transfer roller 134.

According to the present exemplary embodiment, a power supply roller 133 that applies second transfer bias to the backup roller 132 and that is composed of metal is provided.

The toner image that is formed on the intermediate transfer belt 12 is transferred to the paper P that is transported at the second transfer portion 13.

The fixing unit 14 is located downstream of the second transfer portion 13 in the transport direction of the paper P. The fixing unit 14 includes a fixing roller 141 that includes a heating source (not illustrated) and a pressure roller 142 that faces the fixing roller 141 and that presses the fixing roller.

According to the present exemplary embodiment, the paper P that passes through the second transfer portion 13 is transported to a position between the fixing roller 141 and the pressure roller 142, and the toner image that is formed on the paper P and that is not fixed is melted and is fixed to the paper P. Consequently, an image is formed on the paper P from the toner image.

According to the present exemplary embodiment, the image forming apparatus 100 is capable of forming images on both surfaces of the paper P and has a reverse transport path 61 that is used to form the images on both surfaces of the paper P.

The reverse transport path 61 is split from the paper transport path 60 at a position downstream of the fixing unit 14. In the case where the reverse transport path 61 starts at a joint 2A to the paper transport path 60, the reverse transport path 61 extends toward the left-hand direction in the figure and joins the paper transport path 60 at a position upstream of the second transfer portion 13.

In the case where the images are formed on both surfaces of the paper P, the paper P after an image is formed on the first surface is once transported to a position downstream of the joint 2A. Subsequently, the transport direction of the paper P is reversed, and the paper P is fed to the reverse transport path 61 with a trailing edge of the paper P in the transport direction facing forward.

The paper P is supplied to the second transfer portion 13 again via the reverse transport path 61.

Consequently, a toner image is transferred to the second surface of the paper P at the second transfer portion 13. Subsequently, the paper P moves toward the fixing unit 14, and the fixing unit 14 fixes the toner image to the paper P. The images are formed on both surfaces of the paper P by performing this processing.

Aspect of forming the images on both surfaces of the paper P is not limited thereto. For example, image-forming members may be provided for the first surface and the second surface of the paper P, and the images may be formed on both surfaces of the paper P by using the image-forming members that are provided for the respective surfaces of the paper P.

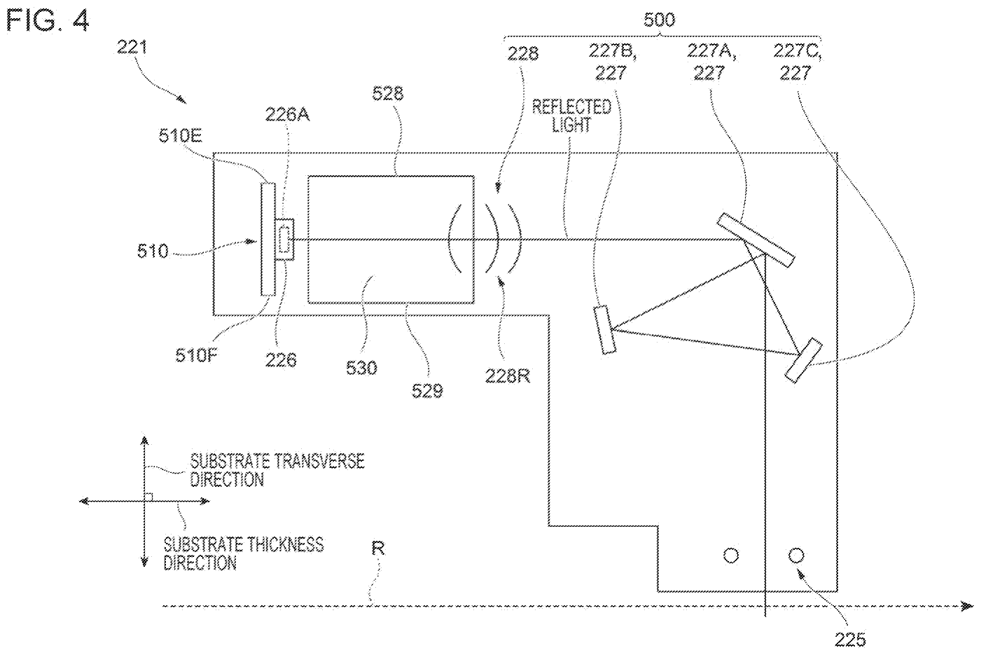

FIG. 4 illustrates an inner structure of the upper image-reading member 221. The lower image-reading member 222 has the same structure as that of the upper image-reading member 221. Accordingly, the lower image-reading member 222 is not described.

According to the present exemplary embodiment, the upper image-reading member 221 includes the light source 225 as described above. The light source 225 radiates light to the paper P (not illustrated in FIG. 4) that passes along the paper transport path R.

The upper image-reading member 221 also includes the light-receiving unit 226 that receives the reflected light from the paper P.

The upper image-reading member 221 also includes an optical member 500 that guides the reflected light from the paper P to the light-receiving unit 226.

According to the present exemplary embodiment, the optical member 500 includes multiple light-reflecting members 227 and the imaging optical system 228. The imaging optical system 228 includes a lens 228R.

The multiple light-reflecting members 227 reflect the reflected light from the paper P toward the light-receiving unit 226.

According to the present exemplary embodiment, the light is radiated from the light source 225 to the paper P, and consequently, the reflected light is reflected from the paper P. The multiple light-reflecting members 227 guide the reflected light from the paper P and causes the reflected light to travel to the light-receiving unit 226.

According to the present exemplary embodiment, a first light-reflecting member 227A, a second light-reflecting member 227B, and a third light-reflecting member 227C are provided as the multiple light-reflecting members 227.

According to the present exemplary embodiment, the light-reflecting members 227 are arranged in the order of the first light-reflecting member 227A, the second light-reflecting member 227B, and the third light-reflecting member 227C in the direction in which the reflected light travels.

According to the present exemplary embodiment, the reflected light is reflected from the first light-reflecting member 227A, the second light-reflecting member 227B, and the third light-reflecting member 227C in this order, and subsequently, the reflected light is reflected from the first light-reflecting member 227A again. Subsequently, the reflected light is guided by the imaging optical system 228 and travels to the light-receiving unit 226.

The light-receiving unit 226 includes the multiple light-receiving elements 226A that are arranged in the single direction as described above. The multiple light-receiving elements 226A are arranged in the direction perpendicular to the sheet in FIG. 4.

According to the present exemplary embodiment, the multiple light-reflecting members 227 extend in the single direction. Specifically, the multiple light-reflecting members 227 extend in the direction perpendicular to the sheet in FIG. 4.

In other words, the multiple light-reflecting members 227 extend in the direction that is perpendicular to the transport direction of the paper P that is transported in the inspection apparatus 200 (see FIG. 1) and that is perpendicular to the thickness direction of the paper P.

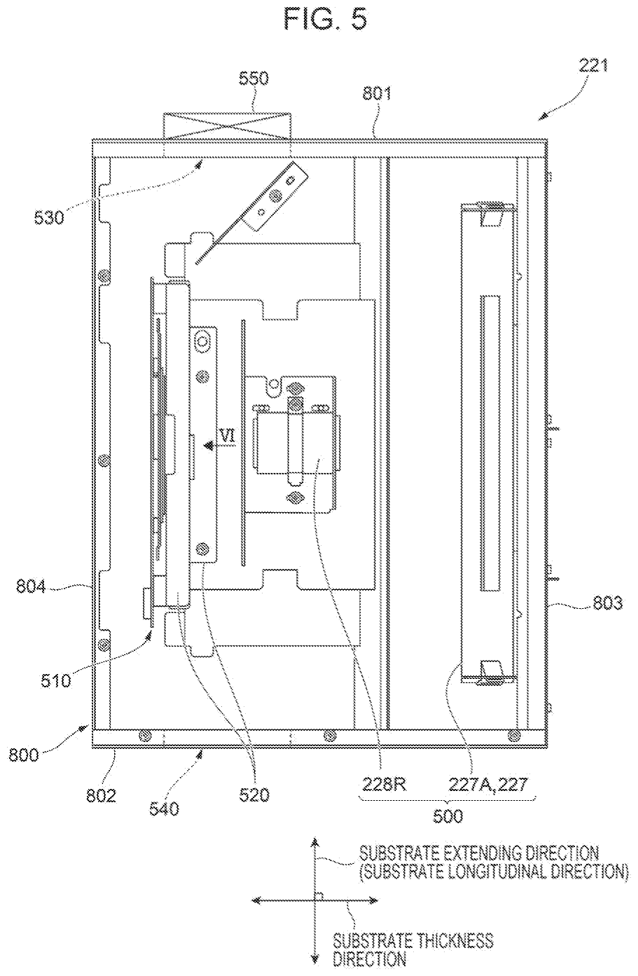

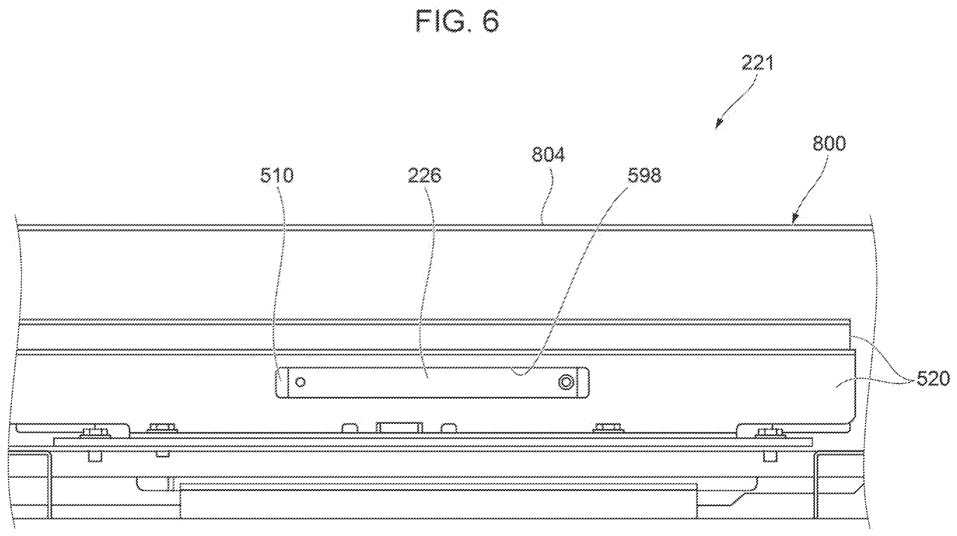

FIG. 5 illustrates the inner structure of the upper image-reading member 221 viewed from above. FIG. 6 illustrates a portion of the upper image-reading member 221 viewed in a direction illustrated by using an arrow VI in FIG. 5.

According to the present exemplary embodiment, as illustrated in FIG. 5, a substrate 510 that has a plate shape is provided. According to the present exemplary embodiment, as illustrated in FIG. 6, the substrate 510 supports the light-receiving unit 226.

As illustrated in FIG. 5, a position-adjusting member 520 is nearer than the substrate 510 to the lens 228R. As illustrated in FIG. 6, the position-adjusting member 520 has an opening 598 through which the reflected light passes. According to the present exemplary embodiment, the light-receiving unit 226 that is supported by the substrate 510 is disposed behind the opening 598. The position-adjusting member 520 will be described in detail later.

According to the present exemplary embodiment, as illustrated in FIG. 5, the optical member 500 is located at a position different from the position of the substrate 510 in a substrate thickness direction corresponding to the thickness direction of the substrate 510.

According to the present exemplary embodiment, as illustrated in FIG. 5, an intake opening 530 for taking cooling gas for cooling the substrate 510 in the upper image-reading member 221 and a discharge opening 540 for discharging the cooling gas are provided.

According to the present exemplary embodiment, the upper image-reading member 221 includes a housing 800 that includes a rear side wall 801 and a front side wall 802. The intake opening 530 is provided in the rear side wall 801. The discharge opening 540 is provided in the front side wall 802.

The housing 800 also includes an optical-member-facing side wall 803 and a substrate-facing side wall 804 that connect the rear side wall 801 and the front side wall 802 to each other.

The optical-member-facing side wall 803 and the substrate-facing side wall 804 extend along the substrate 510. The optical-member-facing side wall 803 faces the optical member 500. The substrate-facing side wall 804 faces the substrate 510.

According to the present exemplary embodiment, as illustrated in FIG. 5, the discharge opening 540 is located at a position different from the position of the intake opening 530 in a substrate extending direction corresponding to a direction in which the substrate 510 extends. According to the present exemplary embodiment, the position of the discharge opening 540 in the substrate extending direction differs from the position of the intake opening 530 in the substrate extending direction.

According to the present exemplary embodiment, the substrate 510 has a rectangular shape. According to the present exemplary embodiment, the discharge opening 540 is located at a position different from the position of the intake opening 530 in the longitudinal direction of the substrate 510 that has a rectangular shape. The substrate extending direction may also be referred to as the longitudinal direction of the substrate 510.

According to the present exemplary embodiment, a fan 550 is provided as an example of a supply unit that supplies the cooling gas that is used to cool the substrate 510 to the substrate 510.

According to the present exemplary embodiment, the fan 550 is disposed at the intake opening 530 and sends the cooling gas into the upper image-reading member 221.

The fan 550 may be disposed at the discharge opening 540 instead of being disposed at the intake opening 530. In this case, the fan 550 discharges the cooling gas via the discharge opening 540, and new cooling gas enters the upper image-reading member 221 via the intake opening 530.

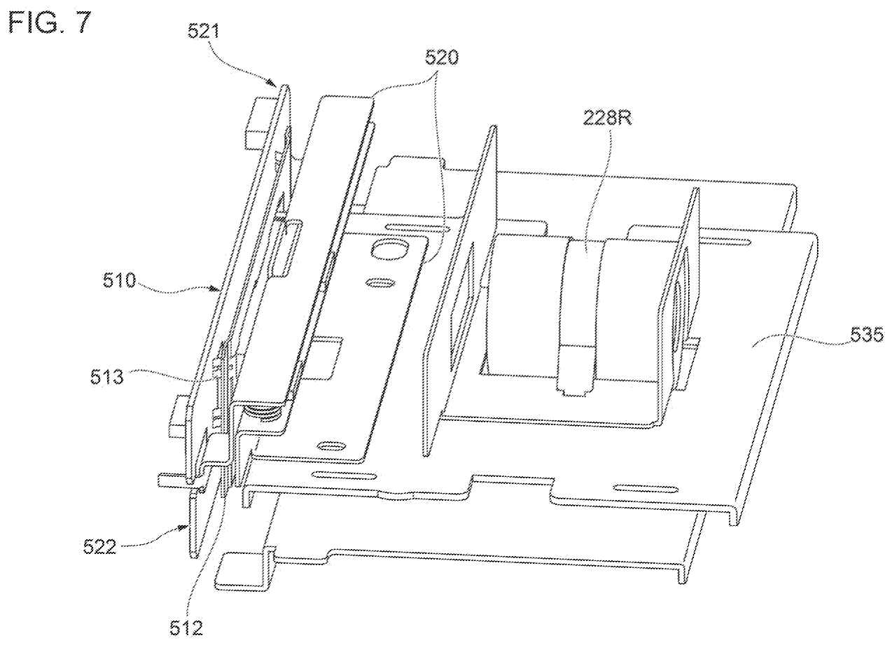

FIG. 7 is a perspective view of the structure of the vicinity of the substrate 510.

According to the present exemplary embodiment, a heat dissipation metal plate 512 that causes the heat of the substrate 510 to escape faces the substrate 510. The heat dissipation metal plate 512 is in contact with the substrate 510 by using a contact member 513. According to the present exemplary embodiment, the heat of the substrate 510 is transferred to the heat dissipation metal plate 512.

There is a gap between the substrate 510 and the heat dissipation metal plate 512. According to the present exemplary embodiment, the light-receiving unit 226 (not illustrated in FIG. 7) generates heat, and the heat is transferred to the substrate 510 and the heat dissipation metal plate 512.

According to the present exemplary embodiment, the position-adjusting member 520 is nearer than the substrate 510 to the lens 228R as described above.

The position-adjusting member 520 has the opening 598 as illustrated in FIG. 6. The reflected light that passes through the lens 228R (see FIG. 7) passes through the opening 598 and travels to the light-receiving unit 226 that is supported by the substrate 510.

According to the present exemplary embodiment, the substrate 510 and the heat dissipation metal plate 512 are mounted on the position-adjusting member 520 (see FIG. 7). According to the present exemplary embodiment, a lens-supporting member 535 that is located below the lens 228R and that supports the lens 228R is provided.

According to the present exemplary embodiment, the position-adjusting member 520 is fixed with respect to the lens-supporting member 535, and the position-adjusting member 520 is capable of moving with respect to the lens-supporting member 535.

According to the present exemplary embodiment, the position-adjusting member 520 moves with respect to the lens-supporting member 535, and the position of the light-receiving unit 226 with respect to the lens 228R consequently changes.

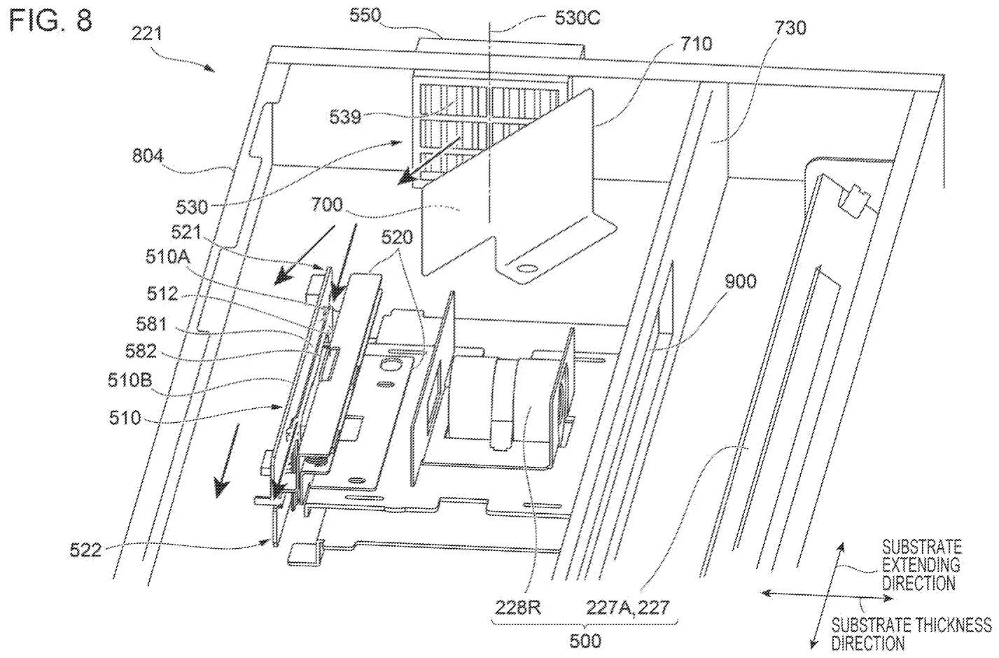

FIG. 8 is a perspective view in the case where an inner portion of the upper image-reading member 221 is viewed from above.

According to the present exemplary embodiment, cooling gas composed of air outside the upper image-reading member 221 first enters the upper image-reading member 221 via the intake opening 530.

According to the present exemplary embodiment, the air is used as the cooling gas. However, gas containing components that differ from those of the air may be used as the cooling gas.

After the cooling gas enters the upper image-reading member 221 via the intake opening 530, the cooling gas moves toward the substrate 510 and is supplied to the substrate 510. The cooling gas that is supplied to the substrate 510 flows along the substrate 510.

More specifically, the cooling gas flows along a light-receiving-unit-facing surface 510A corresponding to a surface of the substrate 510 that faces the light-receiving unit 226 and an opposite surface 510B corresponding to a surface opposite the light-receiving-unit-facing surface 510A.

In the case where the cooling gas flows along the light-receiving-unit-facing surface 510A of the substrate 510, the cooling gas passes through a gap 581 between the substrate 510 and the heat dissipation metal plate 512.

According to the present exemplary embodiment, the cooling gas moves in a gap 582 between the heat dissipation metal plate 512 and the position-adjusting member 520.

According to the present exemplary embodiment, the position of the intake opening 530 in the substrate extending direction differs from the position of the discharge opening 540 (not illustrated in FIG. 8) in the substrate extending direction as described above. In this case, as illustrated in FIG. 8, the cooling gas that is supplied to the substrate 510 flows along the substrate 510.

According to the present exemplary embodiment, the cooling gas that is supplied to the substrate 510 is supplied to a first end portion 521 of the substrate 510, subsequently flows along the substrate 510, and subsequently reaches a second end portion 522 of the substrate 510. Subsequently, the cooling gas is discharged via the discharge opening 540 (see FIG. 5).

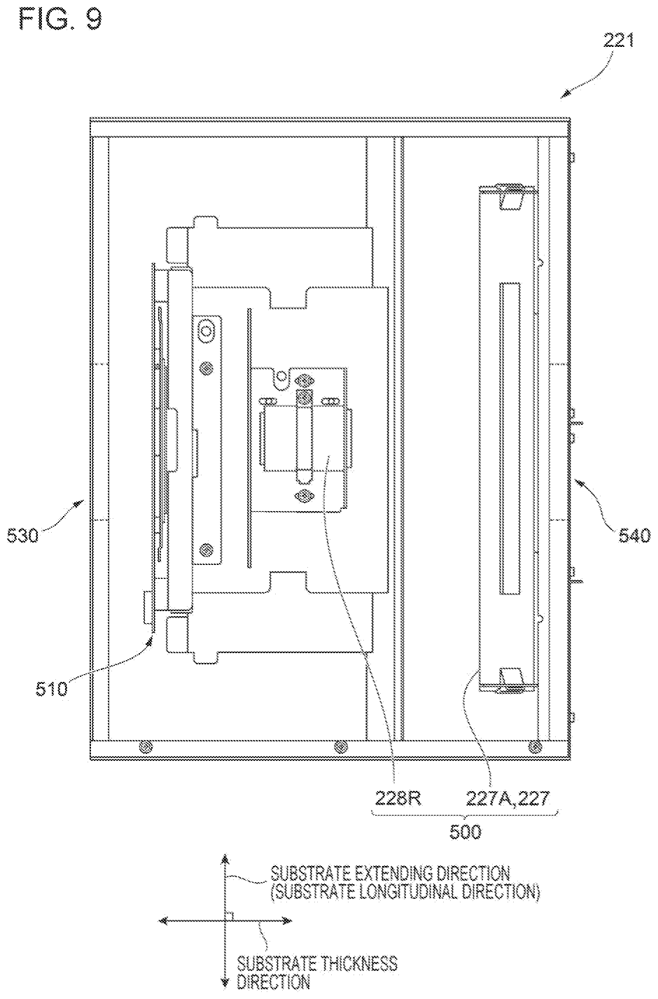

FIG. 9 illustrates a comparative example.

In the comparative example, the position of the intake opening 530 in the substrate extending direction matches the position of the discharge opening 540 in the substrate extending direction, but the position of the intake opening 530 in the substrate thickness direction differs from the position of the discharge opening 540 in the substrate thickness direction.

In the comparative example, the cooling gas that enters the upper image-reading member 221 via the intake opening 530 passes through the optical member 500 before reaching the discharge opening 540. In this case, the dust that is contained in the cooling gas, for example, adheres to the optical member 500, and the optical member 500 is likely to get dirt.

According to the present exemplary embodiment, however, the position of the intake opening 530 in the substrate extending direction differs from the position of the discharge opening 540 in the substrate extending direction. In this way, the cooling gas may be inhibited from moving toward the optical member 500, and dust that is contained in the cooling gas, for example, may be inhibited from adhering to the optical member 500.

The components according to the present exemplary embodiment will be further described with reference to FIG. 8.

According to the present exemplary embodiment, as illustrated in FIG. 8, a central portion 530C of the intake opening 530 in the substrate thickness direction is located at a position in the substrate thickness direction nearer than the position of the substrate 510 in the substrate thickness direction to the optical member 500.

Similarly, as for the discharge opening 540, a central portion 530C of the discharge opening 540 in the substrate thickness direction is located at a position in the substrate thickness direction nearer than the position of the substrate 510 in the substrate thickness direction to the optical member 500 although this is not illustrated in FIG. 8.

According to the present exemplary embodiment, the intake opening 530 and the discharge opening 540 are nearer than the substrate 510 to the optical member 500. In this way, the size of the upper image-reading member 221 may be readily decreased. More specifically, the size of the upper image-reading member 221 in the substrate thickness direction may be readily decreased.

If the intake opening 530 and the discharge opening 540 are nearer than the optical member 500 to the substrate-facing side wall 804, the dimension of the upper image-reading member 221 in the substrate thickness direction is likely to increase.

In many cases, a device such as the fan 550 is installed at the intake opening 530 or the discharge opening 540. If the intake opening 530 and the discharge opening 540 are near the substrate-facing side wall 804, the dimension of the upper image-reading member 221 in the substrate thickness direction is likely to increase, for example, because the device protrudes in the left-hand direction in the figure.

According to the present exemplary embodiment, however, the intake opening 530 and the discharge opening 540 are nearer than the substrate 510 to the optical member 500. In this way, an increase in the dimension of the upper image-reading member 221 in the substrate thickness direction may be avoided. In this way, the size of the upper image-reading member 221 may be readily decreased.

According to the present exemplary embodiment, as illustrated in FIG. 8, a guide portion 700 that guides the cooling gas via the intake opening 530 to the substrate 510 is provided. One of the surfaces of a metal plate 710 that is installed in the upper image-reading member 221 serves as the guide portion 700.

The guide portion 700 inclines with respect to the direction in which the substrate 510 extends.

The guide portion 700 is located between the intake opening 530 and the optical member 500. For this reason, according to the present exemplary embodiment, the guide portion 700 guides the cooling gas to the substrate 510 and restricts movement of the cooling gas toward the optical member 500. The guide portion 700 also functions as a restriction portion that restricts movement of the cooling gas toward the optical member 500.

According to the present exemplary embodiment, a partition wall 730 is disposed between the guide portion 700 and the first light-reflecting member 227A. According to the present exemplary embodiment, the partition wall 730 functions as a restriction portion and restricts movement of the cooling gas toward the first light-reflecting member 227A that functions as a portion of the optical member 500.

According to the present exemplary embodiment, the restriction portion is thus disposed between the intake opening 530 and the optical member 500.

According to the present exemplary embodiment, the multiple restriction portions are disposed between the intake opening 530 and the first light-reflecting member 227A.

Specifically, the guide portion 700 and the partition wall 730 that function as the restriction portions are disposed between the intake opening 530 and the first light-reflecting member 227A.

The partition wall 730 has an opening 900 for causing the reflected light from the first light-reflecting member 227A to travel to the lens 228R.

According to the present exemplary embodiment, as illustrated in FIG. 8, a filter 539 is installed at the intake opening 530. According to the present exemplary embodiment, a filter 539 (not illustrated) is installed also at the discharge opening 540.

The filters 539 are installed to inhibit dust from entering the upper image-reading member 221. According to the present exemplary embodiment, the filters 539 are disposed not only at the intake opening 530 via which the cooling gas enters but also at the discharge opening 540 via which the cooling gas exits.

The filters 539 may not be disposed at both of the intake opening 530 and the discharge opening 540. The filter 539 may be disposed only at the intake opening 530.

The filters 539 that are used are not particularly limited. Known filters may be used as the filters 539.

According to the present exemplary embodiment, as illustrated in FIG. 4, the substrate 510 is located in a region that extends from a first end portion 528 of the intake opening 530 toward a second end portion 529, and the substrate 510 is located in a region that extends from the second end portion 529 of the intake opening 530 toward the first end portion 528 in comparison among the positions of these in a substrate transverse direction corresponding to the transverse direction of the substrate 510.

In other words, according to the present exemplary embodiment, the entire region of the substrate 510 is located between the first end portion 528 and the second end portion 529 of the intake opening 530.

The entire region of the substrate 510 may not be located between the first end portion 528 and the second end portion 529 of the intake opening 530. For example, only a first end portion 510E of the substrate 510 in the transverse direction may be located between the first end portion 528 and the second end portion 529 of the intake opening 530.

For example, only a second end portion 510F of the substrate 510 in the transverse direction may be located between the first end portion 528 and the second end portion 529 of the intake opening 530.

The first end portion 510E or the second end portion 510F of the substrate 510 may be located between the first end portion 528 and the second end portion 529 of the intake opening 530.

Both of the first end portion 510E and the second end portion 510F of the substrate 510 may be located between the first end portion 528 and the second end portion 529 of the intake opening 530.

In the case where the first end portion 510E or the second end portion 510F of the substrate 510 is located between the first end portion 528 and the second end portion 529 of the intake opening 530 or both of the first end portion 510E and the second end portion 510F of the substrate 510 are located therebetween, the cooling gas may be likely to move toward the substrate 510, unlike the case where the entire region of the substrate 510 is not located between the first end portion 528 and the second end portion 529 of the intake opening 530.

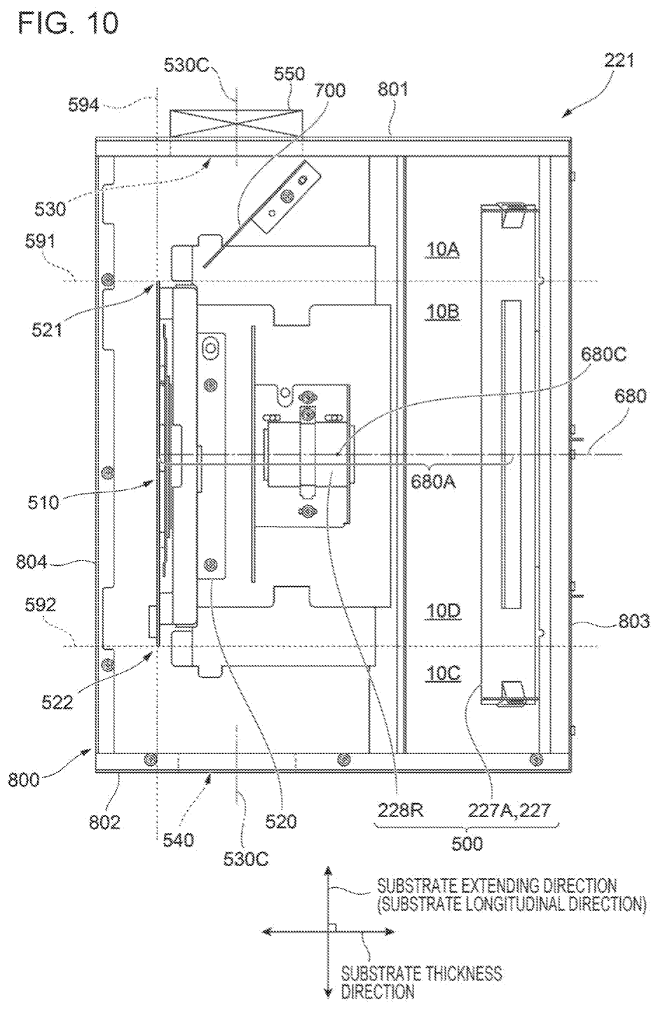

FIG. 10 is a diagram obtained by adding imaginary lines into FIG. 5.

In FIG. 10, a first vertical plane 591 corresponding to a vertical plane that is perpendicular to the substrate extending direction and that passes through the first end portion 521 of the substrate 510 is added and illustrated.

In FIG. 10, a second vertical plane 592 corresponding to a vertical plane that is perpendicular to the substrate extending direction and that passes through the second end portion 522 of the substrate 510 is added and illustrated.

According to the present exemplary embodiment, the substrate 510 includes the first end portion 521 and the second end portion 522 that are located at positions that differ from each other in the substrate extending direction. In other words, the substrate 510 includes the first end portion 521 and the second end portion 522 that are located at positions that differ from each other in the longitudinal direction of the substrate 510.

What is supposed herein is the first vertical plane 591 that is perpendicular to the substrate extending direction and that passes through the first end portion 521 of the substrate 510.

In addition, what is supposed herein is the second vertical plane 592 that is perpendicular to the substrate extending direction and that passes through the second end portion 522 of the substrate 510.

According to the present exemplary embodiment, the intake opening 530 is provided in a region 10A opposite a region 10B in which the second end portion 522 of the substrate 510 is located, of the two regions 10A and 10B that face each other with the first vertical plane 591 interposed therebetween.

According to the present exemplary embodiment, the discharge opening 540 is provided in a region 10C opposite a region 10D in which the first end portion 521 of the substrate 510 is located, of the two regions 10C and 10D that face each other with the second vertical plane 592 interposed therebetween.

According to the present exemplary embodiment, the position of the intake opening 530 in the substrate thickness direction differs from the position of the substrate 510, and the position of the discharge opening 540 in the substrate thickness direction differs from the position of the substrate 510.

According to the present exemplary embodiment, the central portion 530C of the intake opening 530 in the substrate thickness direction is located at a position in the substrate thickness direction nearer than the position of the substrate 510 in the substrate thickness direction to the optical member 500.

Similarly, the central portion 530C of the discharge opening 540 in the substrate thickness direction is located at a position in the substrate thickness direction nearer than the position of the substrate 510 in the substrate thickness direction to the optical member 500.

According to the present exemplary embodiment, the central portion 530C of the intake opening 530 is nearer, to the optical member 500, than an imaginary extension plane 594 that extends from the substrate 510. Similarly, the central portion 530C of the discharge opening 540 is nearer than the extension plane 594 to the optical member 500. The extension plane 594 is an imaginary plane that extends along the substrate 510 and that passes through the substrate 510.

According to the present exemplary embodiment, both of the central portion 530C of the intake opening 530 and the central portion 530C of the discharge opening 540 are nearer than the position of the substrate 510 in the substrate thickness direction to the optical member 500. However, only the central portion 530C of the intake opening 530 or the discharge opening 540 may be nearer than that to the optical member 500.

According to the present exemplary embodiment, the guide portion 700 that guides the cooling gas via the intake opening 530 to the first end portion 521 of the substrate 510 is provided as described above. The guide portion 700 inclines with respect to the substrate extending direction.

The position of the guide portion 700 in the substrate thickness direction is nearer than the position of the substrate 510 in the substrate thickness direction to the optical member 500. The guide portion 700 guides the cooling gas via the intake opening 530 to the first end portion 521 of the substrate 510 and restricts movement of the cooling gas toward the optical member 500 as described above.

According to the present exemplary embodiment, the guide portion 700 guides the cooling gas, and the cooling gas is supplied to the first end portion 521 of the substrate 510 as described above. The cooling gas flows along the substrate 510 and moves toward the second end portion 522 of the substrate 510.

According to the present exemplary embodiment, as illustrated in FIG. 10, supposing a normal 680 to the substrate 510 that passes through the light-receiving unit 226 (see FIG. 6), the first light-reflecting member 227A that serves as the portion of the optical member 500 is disposed on the normal 680.

According to the present exemplary embodiment, supposing a middle point 680C of a part 680A of the normal 680 between the light-receiving unit 226 and the first light-reflecting member 227A, the central portion 530C of the intake opening 530 is located at a position in the substrate thickness direction nearer than the position of the middle point 680C in the substrate thickness direction to the substrate 510.

The central portion 530C of the discharge opening 540 is located at a position in the substrate thickness direction nearer than the position of the middle point 680C in the substrate thickness direction to the substrate 510.

The central portion 530C of the intake opening 530 and the central portion 530C of the discharge opening 540 are nearer than the substrate 510 to the optical member 500. In this way, the size of the upper image-reading member 221 may be decreased as in the above description.

The central portion 530C of the intake opening 530 and the central portion 530C of the discharge opening 540 are nearer than the substrate 510 to the optical member 500. Consequently, the cooling gas may be likely to move toward the optical member 500.

In view of this, according to the present exemplary embodiment, the central portion 530C of the intake opening 530 and the central portion 530C of the discharge opening 540 are nearer than the middle point 680C to the substrate 510. In this way, the size of the upper image-reading member 221 may be decreased, and the amount of the cooling gas that moves toward the optical member 500 may be decreased.

According to the present exemplary embodiment, the central portion 530C of the intake opening 530 is located at a position in the substrate thickness direction nearer than the position of the lens 228R in the substrate thickness direction to the substrate 510.

Similarly, as for the discharge opening 540, the central portion 530C of the discharge opening 540 is located at a position in the substrate thickness direction nearer than the position of the lens 228R in the substrate thickness direction to the substrate 510.

According to the present exemplary embodiment, the lens 228R that is another example of the optical member 500 is disposed on the normal 680 and between the light-receiving unit 226 and the first light-reflecting member 227A.

According to the present exemplary embodiment, the central portion 530C of the intake opening 530 and the central portion 530C of the discharge opening 540 are nearer than the lens 228R to the substrate 510.

In other words, according to the present exemplary embodiment, the central portion 530C of the intake opening 530 and the central portion 530C of the discharge opening 540 are nearer, to the substrate 510, than the lens 228R that corresponds to the optical member 500 nearest to the substrate 510 among the multiple optical members 500.

The central portion 530C of the intake opening 530 and the central portion 530C of the discharge opening 540 are thus nearer, to the substrate 510, than the optical member 500 nearest to the substrate 510. In this way, the cooling gas may be inhibited from moving toward the optical member 500, unlike the case where the central portion 530C of the intake opening 530 and the central portion 530C of the discharge opening 540 are farther from the substrate 510 than the optical member 500 nearest thereto.

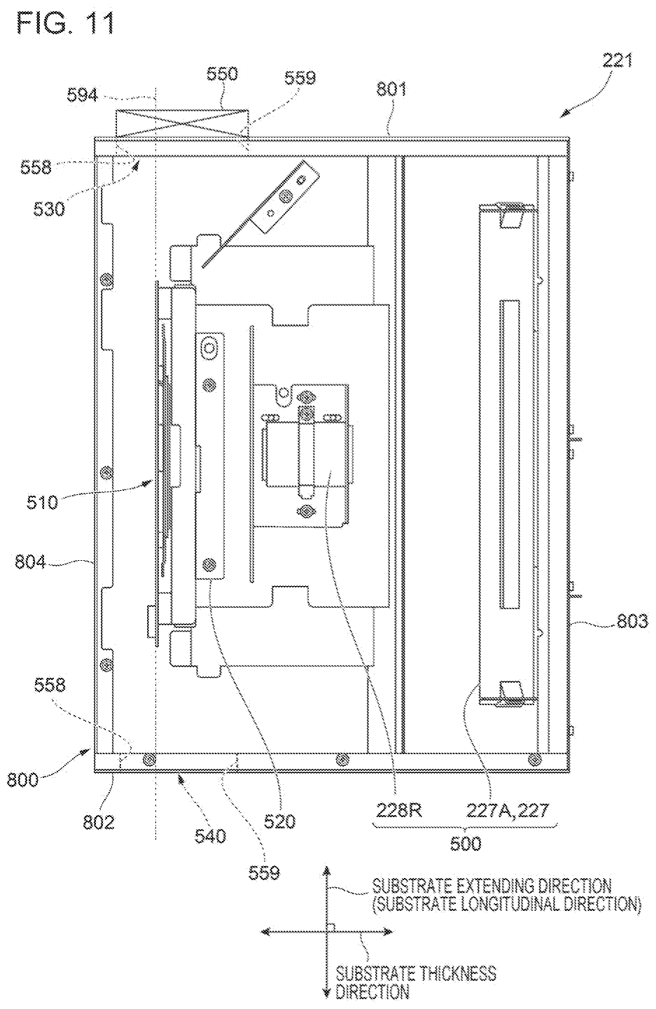

FIG. 11 illustrates another example of the structure of the upper image-reading member 221.

In the example of the structure, the intake opening 530 and the discharge opening 540 are provided on the extension plane 594 that extends from the substrate 510.

The phrase “the intake opening 530 and the discharge opening 540 are provided on the extension plane 594 that extends from the substrate 510” represents that portions of the extension plane 594 cross the intake opening 530 and the discharge opening 540.

The intake opening 530 includes a first end portion 558 and a second end portion 559 that are located at positions that differs from each other in the substrate thickness direction, and the discharge opening 540 includes a first end portion 558 and a second end portion 559 that are located at positions that differs from each other in the substrate thickness direction.

In the substrate thickness direction, the substrate 510 is located between the first end portion 558 and the second end portion 559 of the intake opening 530 and is located between the first end portion 558 and the second end portion 559 of the discharge opening 540.

In the example of the structure illustrated in FIG. 11, the intake opening 530 and the discharge opening 540 are provided on the extension plane 594 from the substrate 510. With this structure, the size of the upper image-reading member 221 is likely to increase, unlike the above example of the structure illustrated in FIG. 5.

In the example of the structure illustrated in FIG. 11, the intake opening 530 and the discharge opening 540 are near the substrate 510, unlike the above example of the structure illustrated in FIG. 5. In this way, the cooling gas may be inhibited from moving toward the optical member 500.

In the example of the structure illustrated in FIG. 11, both of the intake opening 530 and the discharge opening 540 are provided on the extension plane 594 from the substrate 510. However, only one of the openings may be provided on the extension plane 594 from the substrate 510.

The other opening may not be provided on the extension plane 594 from the substrate 510 but may be nearer than the substrate 510 to the optical member 500 as in the example of the structure illustrated in FIG. 5.

Even in the case where the other opening is nearer than the substrate 510 to the optical member 500, the cooling gas may be inhibited from moving toward the optical member 500 more successfully than the case where both of the intake opening 530 and the discharge opening 540 are nearer than the substrate 510 to the optical member 500.

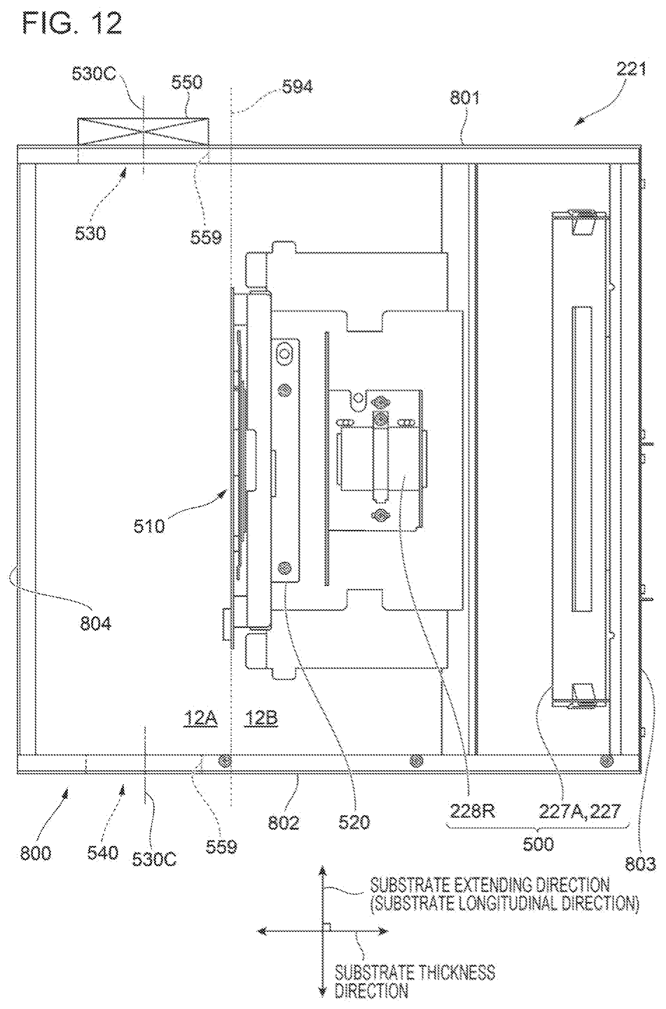

FIG. 12 illustrates another example of the structure of the upper image-reading member 221.

What is supposed herein is the extension plane 594 corresponding to the imaginary plane that extends along the substrate 510 and that passes through the substrate 510.

In this case, a first region 12A and a second region 12B are two regions that face each other with the extension plane 594 interposed therebetween.

In the example of the structure, the central portion 530C of the intake opening 530 is located in the first region 12A opposite the second region 12B in which the optical member 500 is located.

Similarly, in the example of the structure, the central portion 530C of the discharge opening 540 is located in the first region 12A.

Also in the example of the structure, the cooling gas may be inhibited from moving toward the optical member 500 more successfully than the above example of the structure illustrated in FIG. 5.

Both of the central portion 530C of the intake opening 530 and the central portion 530C of the discharge opening 540 may not be located in the first region 12A as in the above description. One central portion 530C of the two central portions 530C may be located in the first region 12A, and the other central portion 530C may be located in the second region 12B.

Even in the case where the other central portion 530C is located in the second region 12B, the cooling gas may be inhibited from moving toward the optical member 500 more successfully than the case where both of the central portion 530C of the intake opening 530 and the central portion 530C of the discharge opening 540 are located in the second region 12B.

In an example of the structure illustrated in FIG. 12, the entire region of the intake opening 530 and the entire region of the discharge opening 540 are located in the first region 12A.

In the example of the structure illustrated in FIG. 12, the intake opening 530 and the discharge opening 540 are provided such that the second end portion 559 of the intake opening 530 and the second end portion 559 of the discharge opening 540 are located in the first region 12A.

In this way, the cooling gas may be further inhibited from moving toward the optical member 500.

Also in this case, the entire region of the intake opening 530 or the entire region of the discharge opening 540 may be located in the first region 12A, and the other opening may be on the extension plane 594 described above as in the above description.

Alternatively, the entire region of the intake opening 530 or the entire region of the discharge opening 540 may be located in the first region 12A, and the entire region of the other opening may be nearer than the extension plane 594 to the optical member 500.

Even in the case where the other opening is on the extension plane 594, or the entire region of the other opening is nearer than the extension plane 594 to the optical member 500, the cooling gas may be inhibited from moving toward the optical member 500 more successfully than the case where both of the intake opening 530 and the discharge opening 540 are on the extension plane 594 or are nearer than the extension plane 594 to the optical member 500.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))
An image-reading apparatus includes: a light-receiving unit that receives reflected light from a recording medium; a substrate that supports the light-receiving unit; an optical member that is located at a position different from a position of the substrate in a substrate thickness direction corresponding to a thickness direction of the substrate and that guides the reflected light from the recording medium to the light-receiving unit; and a supply unit that supplies cooling gas that is used to cool the substrate to the substrate. The cooling gas that is supplied to the substrate flows along the substrate.
(((2)))
As for the image-reading apparatus described in (((1))), the cooling gas that is supplied to the substrate is supplied to a first end portion of the substrate, flows along the substrate, and reaches a second end portion of the substrate.
(((3)))
The image-reading apparatus described in (((1))) or (((2))) further includes: a restriction portion that restricts movement of the cooling gas toward the optical member.
(((4)))
As for the image-reading apparatus described in (((3))), an intake opening for taking the cooling gas in the image-reading apparatus is provided, and the restriction portion is disposed between the intake opening and the optical member.
(((5)))
As for the image-reading apparatus described in (((4))), a plurality of the restriction portions is disposed between the intake opening and the optical member.
(((6)))
As for the image-reading apparatus described in (((1))), an intake opening for taking the cooling gas in the image-reading apparatus is provided, a central portion of the intake opening in the substrate thickness direction is located at a position in the substrate thickness direction nearer than a position of the substrate in the substrate thickness direction to the optical member, and a guide portion guides the cooling gas via the intake opening to the substrate.
(((7)))
As for the image-reading apparatus described in (((6))), the guide portion inclines with respect to a direction in which the substrate extends.
(((8)))
As for the image-reading apparatus described in (((6))) or (((7))), the guide portion is located between the intake opening and the optical member, guides the cooling gas to the substrate, and restricts movement of the cooling gas toward the optical member.
(((9)))
As for the image-reading apparatus described in (((1))), an intake opening for taking the cooling gas in the image-reading apparatus is provided, and a filter is installed at the intake opening.
(((10)))
As for the image-reading apparatus described in (((1))) or (((9))), a discharge opening that is used to discharge the cooling gas from the image-reading apparatus is provided, and a filter is installed at the discharge opening.
(((11)))
An image-reading apparatus includes: a light-receiving unit that receives reflected light from a recording medium; a substrate that supports the light-receiving unit; an optical member that is located at a position different from a position of the substrate in a substrate thickness direction corresponding to a thickness direction of the substrate and that guides the reflected light from the recording medium to the light-receiving unit; and an intake opening for taking in cooling gas that is used to cool the substrate; and a discharge opening that is located at a position different from a position of the intake opening in a substrate extending direction corresponding to a direction in which the substrate extends and that is used to discharge the cooling gas.
(((12)))
As for the image-reading apparatus described in (((11))), the substrate includes a first end portion and a second end portion that are located at positions that differ from each other in the substrate extending direction, and supposing a first vertical plane corresponding to a vertical plane that is perpendicular to the substrate extending direction and that extends through the first end portion, the intake opening is provided in a region opposite a region in which the second end portion is located, of the two regions that face each other with the first vertical plane interposed therebetween.
(((13)))
As for the image-reading apparatus described in (((12))), supposing a second vertical plane corresponding to a vertical plane that is perpendicular to the substrate extending direction and that extends through the second end portion, the discharge opening is provided in a region opposite a region in which the first end portion is located, of the two regions that face each other with the second vertical plane interposed therebetween.
(((14)))
As for the image-reading apparatus described in any one of (((11))) to (((13))), at least one central portion selected from a central portion of the intake opening in the substrate thickness direction and a central portion of the discharge opening in the substrate thickness direction is located at a position in the substrate thickness direction nearer than a position of the substrate in the substrate thickness direction to the optical member.
((15)))
As for the image-reading apparatus described in (((14))), supposing a normal to the substrate that passes through the light-receiving unit, a light-reflecting member that serves as the optical member is disposed on the normal, and supposing a middle point of a part of the normal between the light-receiving unit and the light-reflecting member, the at least one central portion is located at a position in the substrate thickness direction nearer than a position of the middle point in the substrate thickness direction to the substrate.
(((16)))
As for the image-reading apparatus described in (((15))), a lens that serves as an optical member that differs from the optical member is disposed on the normal and between the light-receiving unit and the light-reflecting member, and the at least one central portion is located at a position in the substrate thickness direction nearer than a position of the lens in the substrate thickness direction to the substrate.
(((17)))
As for the image-reading apparatus described in (((11))), the substrate includes a first end portion and a second end portion that are located at positions that differ from each other in the substrate extending direction, supposing a first vertical plane corresponding to a vertical plane that is perpendicular to the substrate extending direction and that extends through the first end portion, the intake opening is provided in a region opposite a region in which the second end portion is located, of the two regions that face each other with the first vertical plane interposed therebetween, a position of the intake opening in the substrate thickness direction differs from a position of the substrate, and a guide portion that inclines with respect to the substrate extending direction and that guides the cooling gas via the intake opening to the first end portion of the substrate is provided.
(((18)))
As for the image-reading apparatus described in (((17))), a central portion of the intake opening in the substrate thickness direction is located at a position in the substrate thickness direction nearer than a position of the substrate in the substrate thickness direction to the optical member, and the guide portion is located such that a position thereof in the substrate thickness direction is nearer than the position of the substrate in the substrate thickness direction to the optical member, guides the cooling gas via the intake opening to the first end portion of the substrate, and restricts movement of the cooling gas toward the optical member.
(((19)))
As for the image-reading apparatus described in (((17))) or (((18))), the cooling gas that is guided by the guide portion and that is supplied to the first end portion of the substrate flows along the substrate and moves toward the second end portion of the substrate.
(((20)))
As for the image-reading apparatus described in (((11))), at least the intake opening or the discharge opening is provided on an extension plane from the substrate.
(((21)))
As for the image-reading apparatus described in (((11))), supposing an imaginary plane that extends along the substrate and that passes through the substrate, at least one central portion selected from a central portion of the intake opening in the substrate thickness direction and a central portion of the discharge opening in the substrate thickness direction is located in a region opposite a region in which the optical member is located, of the two regions that face each other with the plane interposed therebetween.
(((22)))
An image-forming system includes: an image-forming unit that forms an image on a recording medium; an image-reading apparatus that reads the image that is formed on the recording medium by using the image-forming unit; and the image-reading apparatus includes the image-reading apparatus described in any one of (((1))) to (((21))).

What is claimed is:

1. An image-reading apparatus comprising:
a light-receiving unit that receives reflected light from a recording medium;
a substrate that supports the light-receiving unit;
an optical member that is located at a position different from a position of the substrate in a substrate thickness direction corresponding to a thickness direction of the substrate and that guides the reflected light from the recording medium to the light-receiving unit; and
a supply unit that supplies cooling gas that is used to cool the substrate to the substrate,
wherein the cooling gas that is supplied to the substrate flows along the substrate.

2. The image-reading apparatus according to claim 1,
wherein the cooling gas that is supplied to the substrate is supplied to a first end portion of the substrate, flows along the substrate, and reaches a second end portion of the substrate.

3. The image-reading apparatus according to claim 1, further comprising:
a restriction portion that restricts movement of the cooling gas toward the optical member.

4. The image-reading apparatus according to claim 3,
wherein an intake opening for taking the cooling gas in the image-reading apparatus is provided, and
wherein the restriction portion is disposed between the intake opening and the optical member.

5. The image-reading apparatus according to claim 4,
wherein a plurality of the restriction portions is disposed between the intake opening and the optical member.

6. The image-reading apparatus according to claim 1,
wherein an intake opening for taking the cooling gas in the image-reading apparatus is provided,
wherein a central portion of the intake opening in the substrate thickness direction is located at a position in the substrate thickness direction nearer than a position of the substrate in the substrate thickness direction to the optical member, and
wherein a guide portion guides the cooling gas via the intake opening to the substrate.

7. The image-reading apparatus according to claim 6,
wherein the guide portion inclines with respect to a direction in which the substrate extends.

8. The image-reading apparatus according to claim 6,
wherein the guide portion is located between the intake opening and the optical member, guides the cooling gas to the substrate, and restricts movement of the cooling gas toward the optical member.

9. The image-reading apparatus according to claim 1,
wherein an intake opening for taking the cooling gas in the image-reading apparatus is provided, and
wherein a filter is installed at the intake opening.

10. The image-reading apparatus according to claim 1,
wherein a discharge opening that is used to discharge the cooling gas from the image-reading apparatus is provided, and
wherein a filter is installed at the discharge opening.

11. An image-reading apparatus comprising:
a light-receiving unit that receives reflected light from a recording medium;
a substrate that supports the light-receiving unit;
an optical member that is located at a position different from a position of the substrate in a substrate thickness direction corresponding to a thickness direction of the substrate and that guides the reflected light from the recording medium to the light-receiving unit; and
an intake opening for taking in cooling gas that is used to cool the substrate; and
a discharge opening that is located at a position different from a position of the intake opening in a substrate extending direction corresponding to a direction in which the substrate extends and that is used to discharge the cooling gas.

12. The image-reading apparatus according to claim 11,
wherein the substrate includes a first end portion and a second end portion that are located at positions that differ from each other in the substrate extending direction, and
wherein supposing a first vertical plane corresponding to a vertical plane that is perpendicular to the substrate extending direction and that extends through the first end portion, the intake opening is provided in a region opposite a region in which the second end portion is located, of the two regions that face each other with the first vertical plane interposed therebetween.

13. The image-reading apparatus according to claim 12,
wherein supposing a second vertical plane corresponding to a vertical plane that is perpendicular to the substrate extending direction and that extends through the second end portion, the discharge opening is provided in a region opposite a region in which the first end portion is located, of the two regions that face each other with the second vertical plane interposed therebetween.

14. The image-reading apparatus according to claim 11,
wherein at least one central portion selected from a central portion of the intake opening in the substrate thickness direction and a central portion of the discharge opening in the substrate thickness direction is located at a position in the substrate thickness direction nearer than a position of the substrate in the substrate thickness direction to the optical member.

15. The image-reading apparatus according to claim 14,
wherein supposing a normal to the substrate that passes through the light-receiving unit, a light-reflecting member that serves as the optical member is disposed on the normal, and
wherein supposing a middle point of a part of the normal between the light-receiving unit and the light-reflecting member, the at least one central portion is located at a position in the substrate thickness direction nearer than a position of the middle point in the substrate thickness direction to the substrate.

16. The image-reading apparatus according to claim 15,
wherein a lens that serves as an optical member that differs from the optical member is disposed on the normal and between the light-receiving unit and the light-reflecting member, and
wherein the at least one central portion is located at a position in the substrate thickness direction nearer than a position of the lens in the substrate thickness direction to the substrate.

17. The image-reading apparatus according to claim 11,
wherein the substrate includes a first end portion and a second end portion that are located at positions that differ from each other in the substrate extending direction,
wherein supposing a first vertical plane corresponding to a vertical plane that is perpendicular to the substrate extending direction and that extends through the first end portion, the intake opening is provided in a region opposite a region in which the second end portion is located, of the two regions that face each other with the first vertical plane interposed therebetween,
wherein a position of the intake opening in the substrate thickness direction differs from a position of the substrate, and
wherein a guide portion that inclines with respect to the substrate extending direction and that guides the cooling gas via the intake opening to the first end portion of the substrate is provided.

18. The image-reading apparatus according to claim 17,
wherein a central portion of the intake opening in the substrate thickness direction is located at a position in the substrate thickness direction nearer than a position of the substrate in the substrate thickness direction to the optical member, and
wherein the guide portion is located such that a position thereof in the substrate thickness direction is nearer than the position of the substrate in the substrate thickness direction to the optical member, guides the cooling gas via the intake opening to the first end portion of the substrate, and restricts movement of the cooling gas toward the optical member.

19. The image-reading apparatus according to claim 17,
wherein the cooling gas that is guided by the guide portion and that is supplied to the first end portion of the substrate flows along the substrate and moves toward the second end portion of the substrate.

20. The image-reading apparatus according to claim 11,
wherein at least the intake opening or the discharge opening is provided on an extension plane from the substrate.

21. The image-reading apparatus according to claim 11,
wherein supposing an imaginary plane that extends along the substrate and that passes through the substrate, at least one central portion selected from a central portion of the intake opening in the substrate thickness direction and a central portion of the discharge opening in the substrate thickness direction is located in a region opposite a region in which the optical member is located, of the two regions that face each other with the plane interposed therebetween.

22. An image-forming system comprising:
an image-forming unit that forms an image on a recording medium;
an image-reading apparatus that reads the image that is formed on the recording medium by using the image-forming unit; and
the image-reading apparatus includes the image-reading apparatus according to claim 1.
